(19) United States
(12) Patent Application Publication
(10) Pub. No.: US 2012/0179537 A1
(43) Pub. Date: Jul. 12, 2012

(54) SYSTEM AND METHOD FOR RESERVING CUSTOMER LEADS WITHIN A CAMPAIGN MANAGEMENT SYSTEM

(76) Inventor: Benjamin Ceranowski, Cary, NC (US)

(21) Appl. No.: 13/334,696

(22) Filed: Dec. 22, 2011

Related U.S. Application Data
(60) Provisional application No. 61/426,884, filed on Dec. 23, 2010.

(51) Int. Cl. G06Q 30/02

(52) U.S. Cl. 705/14.43

(57) ABSTRACT

A system and method for improving lead selection and optimizing the distribution of campaign messaging by a customer relationship management system. The system and method identifies and reserves customer leads for use with a high value campaign which is not scheduled for execution until some future date and time. The reserved leads are made unavailable for use with lower level campaigns scheduled for execution prior to the execution of the high level campaign.

### CROSS REFERENCE TO RELATED APPLICATIONS

This application claims priority under 35 U.S.C. §119(e) to the following co-pending and commonly-assigned provisional patent application, which is incorporated herein by reference:
Provisional Patent Application Ser. No. 61/426,884, entitled “SYSTEM AND METHOD FOR RESERVING CUSTOMER LEADS WITHIN A CAMPAIGN MANAGEMENT SYSTEM” by Ben Ceranowski; filed on Dec. 23, 2010.

### FIELD OF THE INVENTION

The present invention relates to computer-implemented methods and systems for managing marketing campaigns, and in particular to a system and method for reserving customer leads for use in future marketing campaigns.

### BACKGROUND OF THE INVENTION

Computer-implemented customer relationship management (CRM) systems are used to help companies more effectively understand and communicate with their individual customers. Generally, CRM systems are implemented to support the marketing activities of a company, including modeling customer behavior, personalizing marketing activities directed at customers, and communicating with customers.

Beneficially understanding and influencing customer behavior is the objective of a successful CRM system. The CRM process involves interpreting current customer behavior and modifying business practices to take advantage of customers' natural tendencies and encourage more profitable relationships. CRM is an ongoing process of identifying and creating new value with individual customers over the lifetime of the relationship.

CRM is often characterized as sending the right message to the right customer at the right time through the right channel. CRM involves acquiring knowledge about customers and the market; forming customer management plans based on that knowledge; executing the plans through customer interaction; analyzing the results and refining the process; and automating and administering the marketing environment. These customer management plans may include the creation and implementation of direct marketing campaigns in which a business targets selected customers, or potential customers, with communications and offers in order to influence customer behavior. The selected customers are referred to as leads. However, the over use of customer messaging may detrimentally impact customer relationships or diminish the effectiveness of future marketing campaigns. Systems and methods for improving lead selection and optimizing the distribution of campaign messaging are desired.

### BRIEF DESCRIPTION OF THE DRAWINGS

FIG. 1 is a high-level architectural diagram of a CRM system for managing marketing campaigns.

FIG. 2 is a high-level diagram illustrating the deployment of the CRM system of FIG. 1 as a web-based, multi-tier application.

FIG. 3 is an illustration showing some of the databases maintained within the Relation Database Management Systems included in the CRM system of FIGS. 1 and 2.

FIG. 4 is a simple flow diagram of a communication optimization process employed within the CRM system of FIGS. 1 and 2.

FIGS. 5A and 5B illustrate a simple flow diagram of a process for improving lead selection and optimizing the distribution of campaign messaging in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

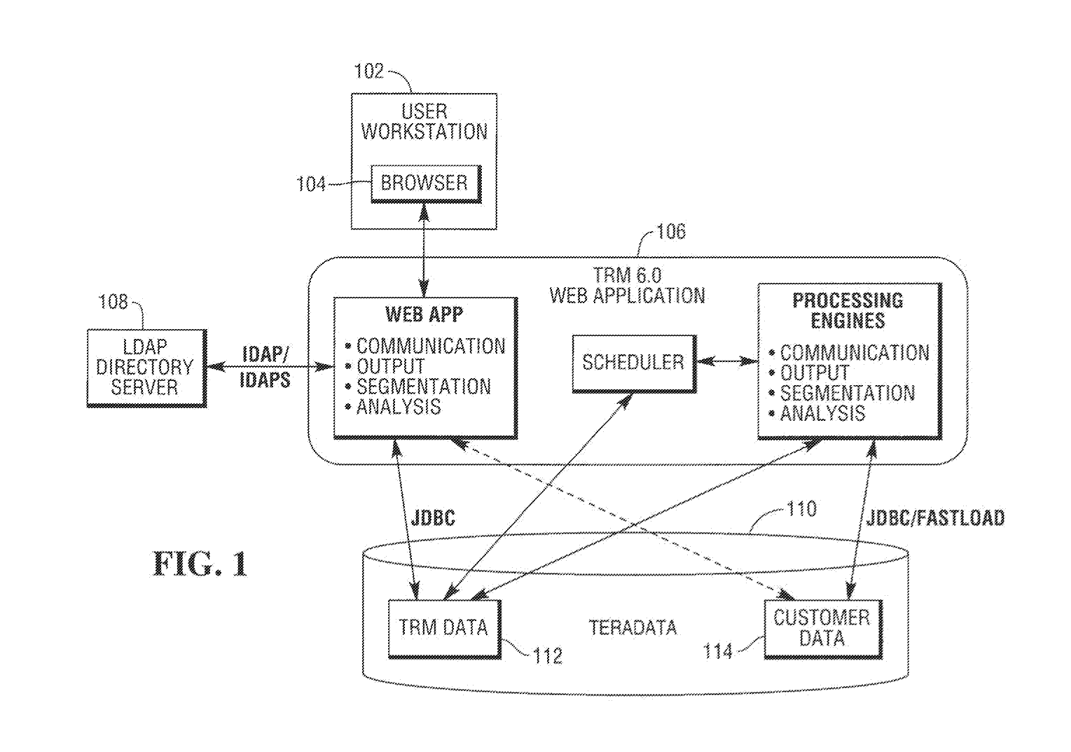

FIG. 1 provides a simple architectural diagram of a CRM system for managing marketing campaigns. The system illustrated in FIG. 1, provided by Teradata Corporation under the name Teradata Relationship Manager is built on an application server framework of base services built with Java EE (Java Enterprise Edition) technology. The application server provides common functions such as security, data base access and logging. Because the Teradata Relationship Manager (TRM) system is a browser-based solution built on an application server, it can be easily deployed throughout a customer's enterprise.

User Interaction with the TRM system is conducted though a client workstation 102 and web browser graphical user interface 104. The solution is built on an application server foundation 106, e.g., IBM WebSphere or Apache Tomcat, interfacing with a Lightweight Directory Access Protocol (LDAP) server 108. The foundation of Teradata Relationship Manager's capabilities is the Teradata Enterprise Data Warehouse (EDW) 110 and related utilities. The Teradata EDW and utilities allow a business to easily collect large amounts of detailed data from various, disparate sources into a single data repository. This data includes TRM system operational data 112 and customer data 114, which may include external data purchased from a third-party, key to targeting for acquiring new customers.

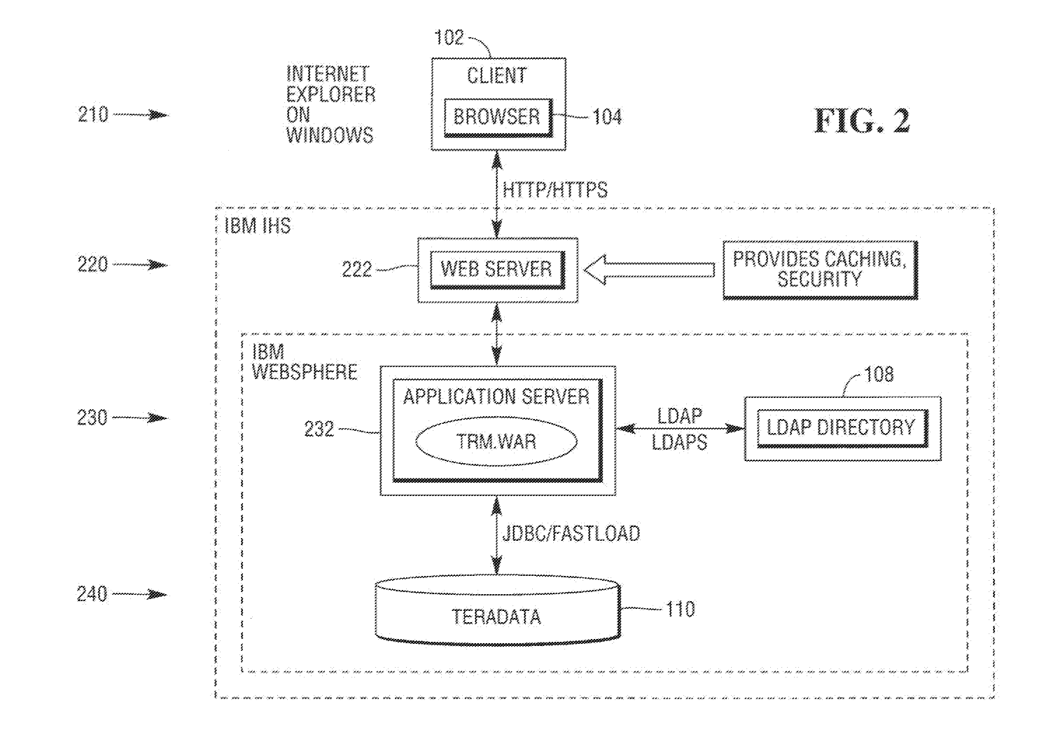

FIG. 2 is a high-level diagram illustrating the deployment of the Teradata Relationship Manger system of FIG. 1 as a web-based, multi-tier application. Teradata Relationship Manager's multi-tier architecture includes a thin client Browser Tier 210, Web Tier 220, Application Tier 230, and Database Tier 240.

Browser Tier 210 includes client workstation 102 and web browser graphical user interface 104. Teradata Relationship Manager uses a thin client: a web browser. This is a zero administration client, i.e., client software can be executed from the server which reduces the cost and hassle of deployment and version control by the IT function. If there is an update, it is updated in one place and all users receive the latest version automatically. This implementation also leverages computing power where needed, in support of multiple users.

Web Tier 220 includes a web server 222. The Web Tier leverages Java EE technology. To access the TRM application, a user types a URL for the TRM system in web browser 104 and the Web Tier displays the TRM system interface as an interactive web page. Web server 222 handles requests for static browser content such as images, JavaScript and Cascading Style Sheets. This implementation reduces the load on application server 232 and allows for more efficient handling of dynamic requests for the application server.

Application Tier 230 includes Java EE a application servers 232 and LDAP directory 108. As a user navigates through and works with the TRM system, the Application Tier supplies the application components. The Application Tier provides the benefits of scalability, componentization, and customization.

Database Tier 240 comprises Teradata EDW 110. All processing such as segment, communication plan, and analysis processing for the TRM system is designed around an “in-database” processing model to leverage the power of the Teradata EDW. The Database Tier contains all the external applications, and operational and customer data stores.

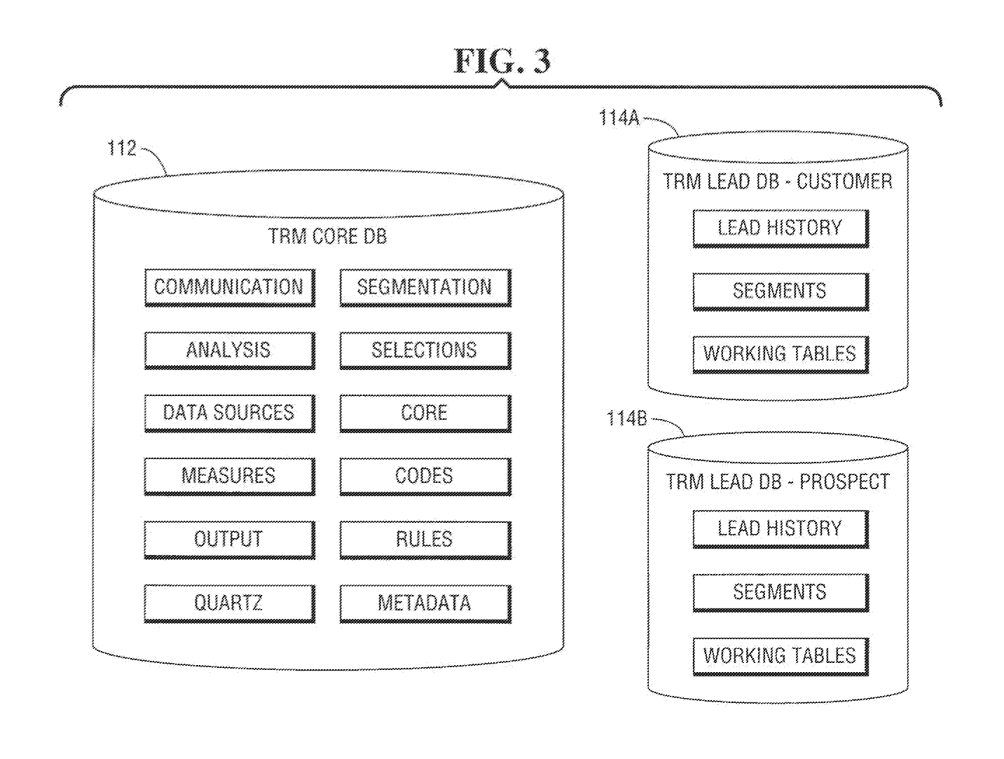

FIG. 3 is an illustration showing some of the data stores maintained within the Teradata EDW, including a TRM system operational data store 112 and customer data stores 114A and 114B. Data store 114A contains customer lead and other data obtained by the TRM system. Data store 114B contains customer lead and other data obtained from external sources.

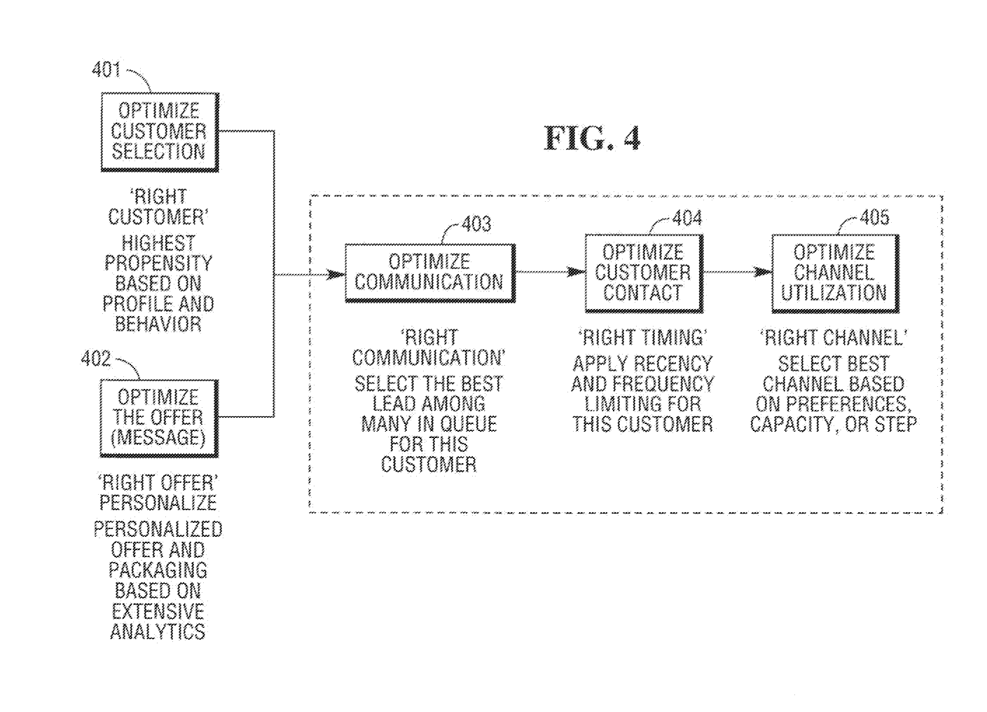

Teradata Relationship Manager assists users in optimizing customer communications by managing the number and frequency of communications that reach a customer, as well as managing the capacity of communication channels. This ensures that all communications take place with the appropriate customers, at the appropriate times, and through the most effective channels. Through Teradata Relationship Manager's optimization features, leads are selected, filtered, and then prioritized based on a company's specified business rules. FIG. 4 is a simple flow diagram of a communication optimization process employed within the TRM system.

Referring to FIG. 4, the TRM system provides a user with the ability to optimize communications based on the following five factors:
401. Optimize customer selection;
402. Optimize the offer for each customer;
403. Optimize the selection of the best of all offers for each customer;
404. Optimize the number and frequency of contact with each customer; and
405. Optimize your use of channels, especially limited channel resources such as call centers or direct mail that have budgetary or other resource constraints.

The Teradata Relationship Manager system applies enterprise business rules and tracks explicit and implicit responses to contextually optimize the number and types of customer communications, as well as the channels used. It prioritizes and manages the number of contacts an individual and/or household can receive over a period of time, based on the type of contact, be it product promotion, services, information, or inquiry.

The Teradata Relationship Manager system also keeps track of how recently and frequently a customer has been contacted and adjusts the subsequent timing based on individual profiles. In addition, by balancing efficiency concerns with the most effective form of communication, Teradata Relationship Manager delivers optimal channel use.

Moreover, the TRM system's optimizer capability allows the optimum set of offers for a customer to be chosen from a bank of potential offers. This Offer Optimizer feature uses a set of scores that are combined into a composite score that will discreetly rank offers for each customer. Examples of scores that can be used in determining the composite score for offer determination can include: customer responsiveness score, customer category rank score (customer spend in a category), category sales lift, and affinity of the offer to lead (model scoring).

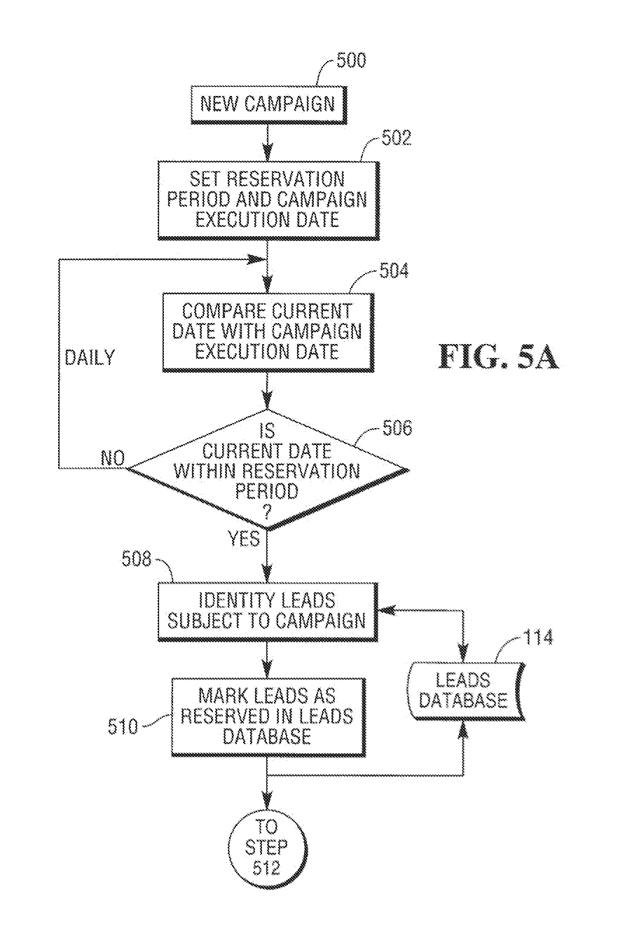

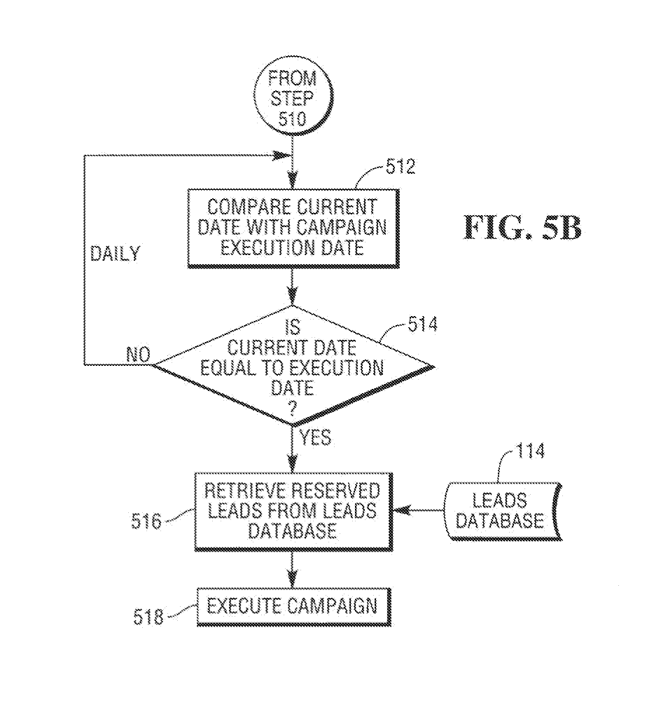

The TRM system provides for the scheduling of a campaign at a later date, however the queries associated with the scheduled campaign are not executed against the TRM database until the campaign is run on the scheduled date and time. Due to the scheduling of campaigns, it is possible that a lower priority campaign will retrieve high value leads from the TRM database, making those leads unavailable for a higher value campaign scheduled to run subsequently. FIG. 5 illustrates a simple flow diagram of a process for reserving high value leads for use in high level campaigns.

In accordance with the lead reservation process illustrated in FIGS. 5A and 5B, a high value campaign will execute its queries ahead of schedule to reserve the high-value leads, even though the campaign will not officially run and output until some future date and time. Each high-value campaign can utilize the lead reservation process by specifying a reservation period in days (step 502). The lead reservation process will periodically compare the current date with the campaign scheduled execution date to identify the point when the current date is within the campaign reservation period (steps 504 and 506).

Once it has been determined that the current date is within the reservation period for the high level campaign, the lead reservation process will instruct the TRM system to identify leads subject to the campaign (step 508), assigning the leads to the high value campaign and marking the leads as contacted in the TRM database (step 510). For example, a campaign with a reservation period of seven days will begin to generate and hold leads seven days prior to scheduled campaign execution. The generated leads will be marked in the database as reserved so no other campaign can retrieve the same lead. When the seven days of generation and reservation have passed, the high value campaign will run and the leads will be output for marketing contact.

When the campaign is subsequently identified for execution by the TRM system (steps 512 and 514), the reserved lead data is retrieved from the TRM database and campaign is executed utilizing the retrieved lead data.

Since data about each lead can change frequently, it is possible that a lead generated on the first day of reservation may not qualify for the high value campaign in a future reservation run. For example, this could happen because a customer is scored lower by a new run of analytics, or because the window of purchase activity has expired. Since this lead no longer qualifies for the high value campaign, and since the lead has only been reserved and has not been contacted, the lead will be recycled. This will free up the lead and make it once again available for future campaigns.

Other scheduled and running campaigns will check to make sure the leads being generated for the campaign do not include any reserved leads. This will filter out reserved leads from all other campaigns and prevent the leads from being included in other marketing communications.

The lead reservation process illustrated in FIGS. 5A and 5B integrates with the existing TRM system framework and contact strategies set by Teradata Relationship Manager. Setting the reservation period is compatible with the existing scheduling framework and paradigm. By marking high value leads as contacted by a reservation campaign, all existing TRM system contact policy and recency settings can be applied and carried out. Using the recycling of leads capability ensures that do not qualify will not be withheld from other campaigns due to over-reservation by a high value campaign.

### CONCLUSION

The Figures and description of the invention provided above reveal a novel system and method for improving lead selection and optimizing the distribution of campaign messaging by a customer relationship management system. The described system and method identifies and reserves customer leads for use with a high value campaign which is not scheduled for execution until some future date and time, the reserved leads being unavailable for use with lower level campaigns scheduled for execution prior to the execution of the high level campaign.

Instructions of the various software routines discussed herein, such as the methods illustrated in FIGS. 5A and 5B, are stored on one or more storage modules in the system shown in FIGS. 1 and 2 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching.

What is claimed is:

1. A computer-implemented method for optimizing lead selection within a marketing campaign system, the method comprising the steps of:
maintaining, on a computer, an electronic database of customer lead information;
identifying, by said computer, customer leads for targeting by a high value campaign;
marking, by said computer, the customer leads identified for targeting by said high value campaign as reserved in said electronic database; and
removing, by said computer, said reserved customer leads from targeting by lower value campaigns.

2. The computer-implemented method in accordance with claim 1, further comprising the step of:
specifying a reservation period for said reserved leads; and
said step of removing, by said computer, said reserved customer leads from targeting by lower value campaigns is applied to lower value campaigns occurring during said reservation period.

3. The computer-implemented method in accordance with claim 1, further comprising the steps of:
specifying a campaign execution date for said high value campaign;
retrieving, by said computer, said reserved customer leads from said electronic database on said execution date; and
executing, by said computer, said high value campaign.

4. The computer-implemented method in accordance with claim 3, further comprising the steps of:
marking, by said computer, said reserved customer leads retrieved from said electronic database as available for targeting by new campaigns in said electronic database.

5. The computer-implemented method in accordance with claim 3, wherein:
said reservation period ends on said campaign execution date.

6. A system for optimizing lead selection for a marketing campaign, comprising:
a data storage device containing an electronic database of customer lead information;
a computer in communication with said data storage device, said computer executing a program for:
identifying customer leads for targeting by a high value campaign;
marking the customer leads identified for targeting by said high value campaign as reserved in said electronic database; and
removing said reserved customer leads from targeting by lower value campaigns.

7. The system in accordance with claim 6, wherein:
said computer receives a reservation period for said reserved leads; and
said step of removing, by said computer, said reserved customer leads from targeting by lower value campaigns is applied to lower value campaigns occurring during said reservation period.

8. The system in accordance with claim 6, wherein:
said computer receives a campaign execution date for said high value campaign; and
said computer:
retrieves said reserved customer leads from said electronic database on said execution date; and
executes said high value campaign.

9. The system in accordance with claim 6, wherein
said computer marks said reserved customer leads retrieved from said electronic database as available for targeting by new campaigns in said electronic database.

10. The system in accordance with claim 6, wherein
said reservation period ends on said campaign execution date.

11. A computer program, stored on a tangible storage medium, for optimizing lead selection within a marketing campaign system, the program including executable instructions that cause a computer to:
access an electronic database of customer lead information;
identify customer leads for targeting by a high value campaign;
mark the customer leads identified for targeting by said high value campaign as reserved in said electronic database; and
remove said reserved customer leads from targeting by lower value campaigns.

12. The computer program, stored on a tangible storage medium, in accordance with claim 11, wherein:
said computer in accordance with said instructions receives a reservation period for said reserved leads; and
said step of removing said reserved customer leads from targeting by lower value campaigns is applied to lower value campaigns occurring during said reservation period.

13. The computer program, stored on a tangible storage medium, in accordance with claim 11, wherein said executable instructions cause said computer to:
receive a campaign execution date for said high value campaign;
retrieve said reserved customer leads from said electronic database on said execution date; and
execute said high value campaign.

14. The computer program, stored on a tangible storage medium, in accordance with claim 13, wherein said executable instructions cause said computer to:
mark said reserved customer leads retrieved from said electronic database, as available for targeting by new campaigns in said electronic database.

15. The computer program, stored on a tangible storage medium, in accordance with claim 13, wherein:
said reservation period ends on said campaign execution date.
